(19) United States
(12) Patent Application Publication
(10) Pub. No.: US 2012/0276263 A1
(43) Pub. Date: Nov. 1, 2012

(54) METHOD OF PROCESSING FOOD FROM PLANTS AND PROCESSING APPARATUS THEREOF

(76) Inventors: Sheng-I Lu, Kaohsiung (TW); Huang Chiung-Cheng, Kaohsiung (TW); Huang Ting-Chang, Kaohsiung (TW); Lu Jyun-I, Kaohsiung (TW); Lu Jhen-I, Kaohsiung (TW)

(21) Appl. No.: 13/455,092

(22) Filed: Apr. 24, 2012

(30) Foreign Application Priority Data
Apr. 26, 2011 (TW) 100114471

(51) Int. Cl. A47J 43/04; A23P 1/00; A23L 1/212

(52) U.S. Cl. 426/392; 241/65

(57) ABSTRACT

A method of processing food from plants and processing apparatus thereof is provided. The cost effective method includes selecting, preliminary processing, soaking, wind drying, cool drying, coarse pulverizing, and fine pulverizing into nanometer scale food powder. The food powder can be easily consumed by human being. It can be preserved for a prolonged period of time. It is nutritious. Moreover, the food powder is easy to store and transport in a space saving manner.

### BACKGROUND OF THE INVENTION

1. Field of the Invention

The invention relates to food production and more particularly to a method of processing food from various plants and a processing apparatus thereof.

2. Description of Related Art

Food is any substance consumed to provide nutritional support for the body. It is usually of plant or animal origin, and contains essential nutrients. Today most of the food energy consumed by the world population is supplied by the food industry. However, food production is still insufficient to meet demand. It is estimated by UN that there are about 1 billion people suffer hunger. Animals such as cows, horses, sheep and elephants can consume plants as food. This is because their stomachs can digest plant fibers into powder of nanometers. Therefore, pulverizing plant fibers into powder of nanometers which can be consumed by humans may solve the food crisis of the world.

Typically, food pulverization may be classified as dry pulverization and wet pulverization. For dry pulverization, its high heat can destroy the nutrients of the plants. Further, powder of 50 μm size are the smallest powder that can be obtained by the dry pulverization. Hence, essential nutrients of the plants cannot be released due to the intactness of the cells. It does not allow humans to quickly absorb the nutrients. Wet pulverization can obtain powder of less than 50 μm. Wet pulverization involves mixing powder with solvent to form a solution and adding separating agents to the solution for preventing coagulation. Further, steps of filtering and drying the filtered solution are required if nanometer order powder are desired. Thus, a successful wet pulverization depends on above factors such as solvent, separating agents, filter, and drying. However, wet pulverization has one drawback of missing nutrients of the plants due to the mixing of solvent and food powder.

Typically, plant-based foods are dried and stored for a prolonged period of time prior to packaging for sell. However, essential nutrients contained in the food may have been lost. It is typically that food manufacturing companies may pulverize plants into powder prior to selling to customers. However, as stated above, high heat of the dry pulverization can destroy the nutrients of the plants. For wet pulverization, it has one drawback of missing nutrients of the plants due to the mixing of solvent and food powder. Further, its manufacturing cost is prohibitively high and efficiency is low. Thus, the need for improvement still exists.

### SUMMARY OF THE INVENTION

It is therefore one object of the invention to provide a method of processing food comprising the steps of (A) collecting and storing non-toxic, no heavy metal polluted plants as food sources; (B) separating, classifying, and cutting the plants; (C) soaking the plants in water containing 20-60 ppm of oxygen for about 20 minutes; (D) drying the plants by blowing in the wind in about 35° C.; (E) further drying the plants by freezing; (F) pulverizing the dried plants into coarse food powder sized about 100pm; (G) further pulverizing the coarse food powder into nanometer scale food powder sized less than 1 μm; and (I) packaging the food additives added nanometer scale food powder into packages.

It is another object of the invention to provide an apparatus of processing food comprising a tank; a drying device; a refrigeration device; a coarse grinder; a fine grinder; and a blending device all disposed in an upstream to downstream configuration.

Above method of the invention can be briefed by comprising the steps of soaking the plants in water containing 20-60 ppm of oxygen for about 20 minutes; drying the plants by blowing in the wind; further drying the plants by freezing; pulverizing the dried plants into coarse food powder sized about 100 μm; further pulverizing the coarse food powder into nanometer scale food powder sized less than 1 μm; and packaging the nanometer scale food powder into packages such as cartons, tablets, capsules, or cartons containing the nanometer scale food powder being solved.

The invention involves grinding plants into fine food powder sized less than 1 μm so as to substantially releasing nutrients contained in the food powder. People can pour the powder into cup filled with warm water prior to drinking. The powder of the invention can be packaged in the forms of tablet or capsule for consumption. Alternatively, the powder of the invention can be packaged in cartons containing solved fine food powder as food manufacturer selection.

It is a further object of the invention to provide a method of processing food comprising the steps of (A) collecting and storing non-toxic, no heavy metal polluted plants as food sources; (B) separating, classifying, and cutting the plants; (C) soaking the plants in water containing 20-60 ppm of oxygen for about 20 minutes; (D) drying the plants by blowing in the wind in about 35° C.; (E) further drying the plants by freezing; (F) pulverizing the dried plants into coarse food powder sized about 100 pm; (G) further pulverizing the coarse food powder into nanometer scale food powder sized less than 1 μm; (H) adding food additives to the nanometer scale food powder; and (I) packaging the food additives added nanometer scale food powder into packages.

Above method of the invention can be briefed by comprising the steps of soaking the plants; drying the plants; further drying the plants by freezing; pulverizing the dried plants into coarse food powder further pulverizing the coarse food powder into nanometer scale food powder sized less than 1 μm; and packaging the nanometer scale food powder into packages such as cartons, tablets, capsules, or cartons containing the nanometer scale food powder being solved. Nutrients contained in the nanometer scale food powder can be quickly absorbed by human beings.

The nanometer scale food powder of the invention can be used as health food, snack food, medicinal food. Further, its packages comprise as cartons, tablets, capsules, and cartons containing the nanometer scale food powder being solved. They can be mixed with warn water for making a drink. Also, it is beneficial to the health.

The invention has the following advantages: It involves soaking plants in water full of oxygen for revitalizing cells. Such plant-based foods can be employed as food reserves, emergency foods, and foods for disaster relief. Further, it can solve world hunger crisis. 800 kg powder can be obtained from 10 tons plants. Thus, the invention can obtain nutrients from plants, reduce food weight, save storage space, decrease transportation cost, and facilitate shipping. Wind drying and cool drying steps are performed so as to preserve nutrients contained in the plants. Further, fine plant powder can be quickly absorbed for providing sufficient energy for daily work. It involves a dry pulverization step to grind plants into fine food powder sized less than 1 μm by using a fine grinder by breaking cell walls of the food powder in a low temperature environment so as to substantially releasing nutrients contained in the food powder. People can pour the powder into cup filled with warm water prior to drinking. It involves a wet pulverization step to grind plants into fine food powder sized less than 1 μm by using a fine grinder by breaking cell walls of the food powder in a low temperature environment so as to substantially releasing nutrients contained in the food powder. After eating, the fine plant powder can be quickly absorbed by digestive organs of human beings. It involves soaking plants in water full of oxygen for revitalizing cells. Such plant-based foods are beneficial to health. The plant-based foods can be mixed with other food powder to prepare packaged foods. They are very good to health. The nanometer scale food powder can be packaged in the forms of tablet or capsule for consumption. Alternatively, it can be packaged in cartons containing solved fine food powder as food manufacturer selection.

The above and other objects, features and advantages of the invention will become apparent from the following detailed description taken with the accompanying drawings.

### BRIEF DESCRIPTION OF THE DRAWINGS

FIG. 1 is a flow chart diagram of a method of processing food from plants according to a first preferred embodiment of the invention;

FIG. 2 is a block diagram of a processing apparatus according to the invention associated with the method of FIG. 1;

FIG. 3 schematically depicts elements of FIG. 2;

FIG. 4 is a flow chart diagram of a method of processing food from plants according to a second preferred embodiment of the invention;

FIG. 5 is a block diagram of a processing apparatus according to the invention associated with the method of FIG. 4; and

FIG. 6 schematically depicts elements of FIG. 5.

### DETAILED DESCRIPTION OF THE INVENTION

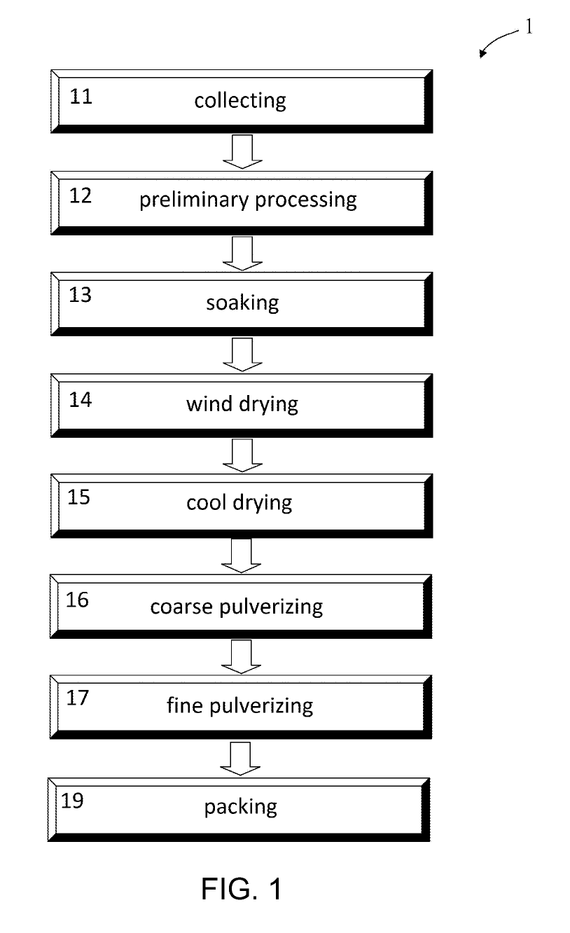

Referring to FIGS. 1 to 3, a method 1 of processing food from plants and processing apparatus thereof in accordance with a first preferred embodiment of the invention are illustrated below.

As illustrated in FIG. 1, the method 1 comprises the following steps:

(A) Collecting step 11 involves collecting non-toxic, no heavy metal polluted plants as food source and storing same.

(B) Preliminary processing step 12 involves separating, classifying and cutting the plants from (A).

(C) Soaking step 13 involves soaking the plants from (B) in water containing 20-60 ppm oxygen for about 20 minutes so as to revitalize cells of the plants.

(D) Wind drying step 14 involves drying the plants from (C) by blowing in the wind in an environment of about 35° C. so as to preserve nutrients contained in the plants.

(E) Cool drying step 15 involves drying the plants from (D) by freezing in order to removing excess water and preserving the nutrients of the plants.

(F) Coarse pulverization step 16 involves pulverizing the plants from (E) into food powder sized about 100 pm by a coarse grinder in a low temperature environment.

(G) Fine pulverization step 17 involves further pulverizing the food powder from (F) into fine food powder sized less than 1 μm by using a fine grinder by breaking cell walls of the food powder in a low temperature environment so as to substantially releasing nutrients contained in the food powder.

(H) Packaging step 19 involves packaging the fine food powder from (G) into cartons, tablets, capsules, or cartons containing solved fine food powder as food manufacturer selection.

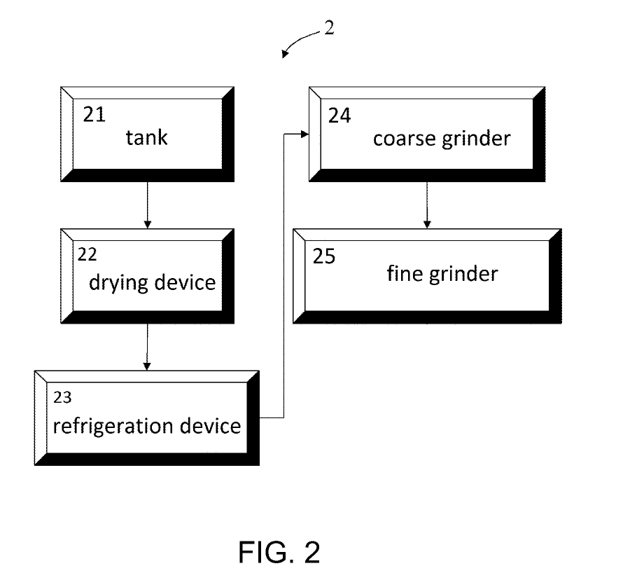

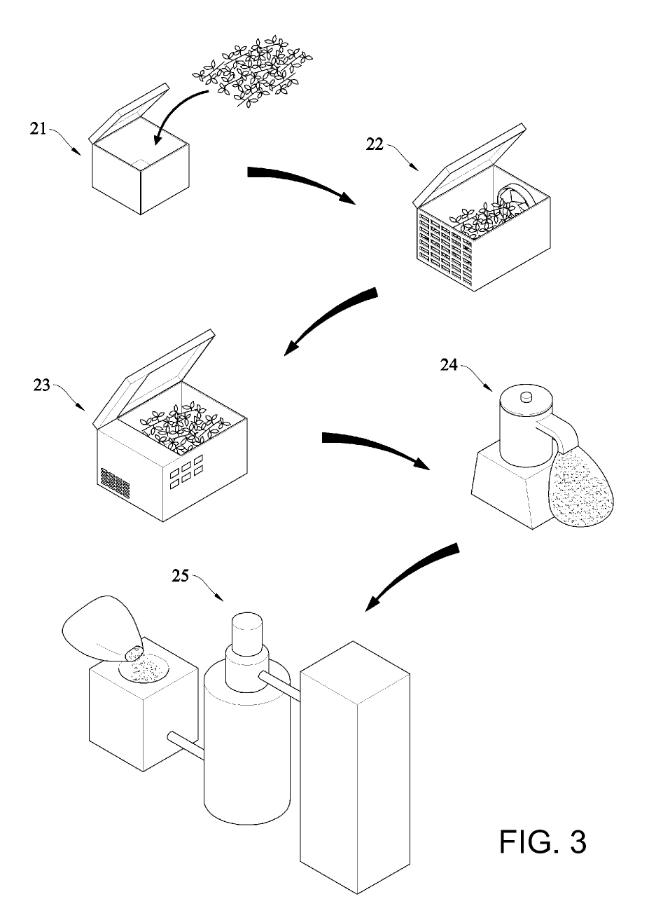

As shown in FIGS. 2 and 3, the processing apparatus 2 comprises a tank 21 associated with soaking step 13; a drying device 22 associated with wind drying step 14; a refrigeration device 23 disposed downstream of the drying device 22 for carrying out cool drying step 15; a coarse grinder 24 disposed downstream of the refrigeration device 23 for carrying out coarse pulverization step 16 in a low temperature environment; and a fine grinder 25 disposed downstream of the coarse grinder 24 for carrying out fine pulverization step 17 in a low temperature environment.

The processing apparatus is the subject of China Invention Patent No. CN101381177 and is characterized in that soaking the plants in water containing high oxygen for about 20 minutes, wind drying the plants by using a drying device 22, cool drying the plants by using a refrigeration device 23, coarse pulverizing the plants into food powder sized about 100 μm by a coarse grinder 24 in a low temperature environment, fine pulverizing the coarse food powder into fine food powder sized less than 1 μm by using a fine grinder 25 by breaking cell walls of the coarse food powder in a low temperature environment, and packaging the fine food powder into cartons, tablets, capsules, or cartons containing solved fine food powder capsules as food manufacturers selection.

Consumers may pour water into a container (e.g., cup) filled with fine food powder to solve same prior to drinking. Alternatively, consumers may eat the tablets or capsules, or drink the carton containing solved fine food powder directly. Moreover, the food materials chosen by the invention are processed by wind drying in low temperature and cool drying so that water contents is greatly decreased. Typically, about 80-90 wt % of the plants are removed. For example, 800 kg powder can be obtained from 10 tons plants.

Thus, the invention can obtain nutrients from plants, reduce food weight, save storage space, decrease transportation cost, and facilitate shipping. Moreover, a small amount consumption of the food powder of the invention is sufficient for the energy of several hours work. Further, the food powder of the invention can be packaged as cartons and consumers can open and pour powder into a cup filled with water prior to drinking. Alternatively, the food powder of the invention can be packaged as tablets or capsules for consumption. Still alternatively, a person may drink the carton containing solved fine food powder directly.

Nowadays, health is concerned by more and more people throughout the world. Thus, green teas, roses, jasmine teas, or the like are popular drinking materials. Typically, people pour hot water into a cup filled with teas for brewing for several minutes. However, it may destroy nutrients of the tea. To the contrary, powder sized less than 1 μm can be obtained by performing above steps of the invention. Further, nutrients of the plant-based foods are sufficiently released from it due to breakage of cell walls. Thus, people may pour water into a cup filled with the food powder of the invention prior to drinking. Alternatively, people may eat the food powder packaged in capsules or tablets according to the invention.

Any ordinary artisans may take advantage of the food processing method of the invention to process other food sources such as oats, grains, yams, potatoes, beans, high nutrition, non-toxic, non heavy metal polluted herbs, edible flowers, etc. Thus, a great variety of food sources can be employed by the invention. It is envisaged by the invention that the food processing method of the invention can solve the hunger crisis of the world if being implemented.

Moreover, any ordinary artisans may take advantage of the food processing method of the invention to process still other food sources such as ginseng, cinnamon, grains of paradise, etc. into powder sized less than 1 μm (i.e., nanometer grade). Such nanometer powder can be quickly consumed by humans.

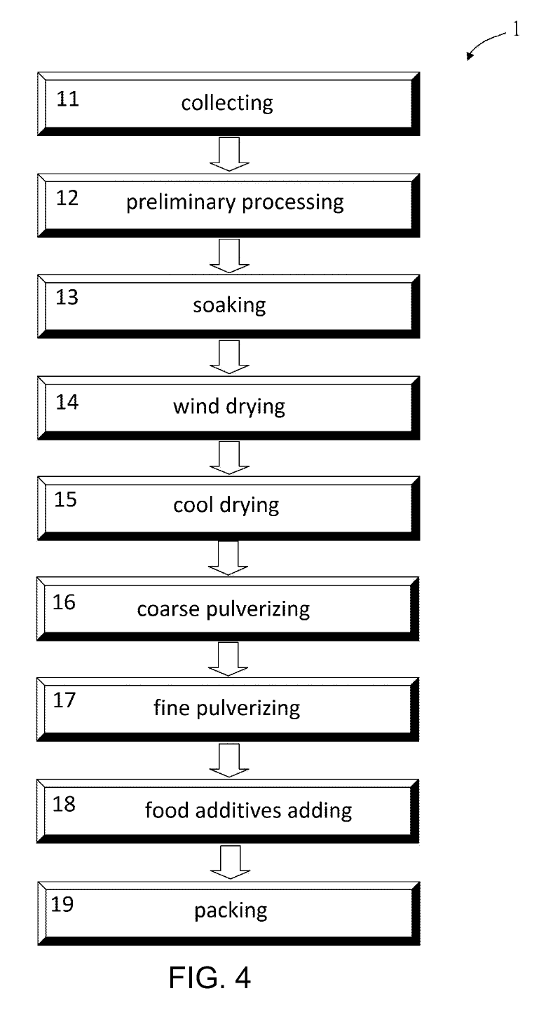

Referring to FIGS. 4 to 6, a method 1 of processing food from plants and processing apparatus thereof in accordance with a second preferred embodiment of the invention are illustrated below.

As illustrated in FIG. 4, the method 1 comprises the following steps:

(A) Collecting step 11 involves collecting non-toxic, no heavy metal polluted plants as food source and storing same.

(B) Preliminary processing step 12 involves separating, classifying and cutting the plants from (A).

(C) Soaking step 13 involves soaking the plants from (B) in water containing 20-60 ppm oxygen for about 20 minutes so as to revitalize cells of the plants.

(D) Wind drying step 14 involves drying the plants from (C) by blowing in the wind in an environment of about 35° C. so as to preserve nutrients contained in the plants.

(E) Cool drying step 15 involves drying the plants from (D) by freezing in order to removing excess water and preserving the nutrients of the plants.

(F) Coarse pulverization step 16 involves pulverizing the plants from (E) into food powder sized about 100 μm by a coarse grinder in a low temperature environment.

(G) Fine pulverization step 17 involves further pulverizing the food powder from (F) into fine food powder sized less than 1 μm by using a fine grinder by breaking cell walls of the food powder in a low temperature environment so as to substantially releasing nutrients contained in the food powder.

(H) Food additives adding step 18 involves adding desired substances (e.g., other plant-based food powders) to the fine food powder from (G) in order to preserve flavor and/or enhance its taste and appearance.

(I) Packaging step 19 involves packaging the food additives added fine food powder from (H) into cartons, tablets, capsules, or cartons containing solved fine food powder as food manufacturer selection.

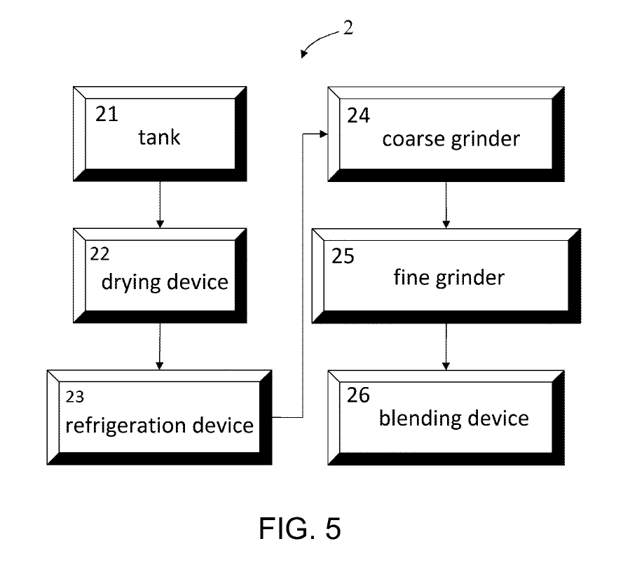

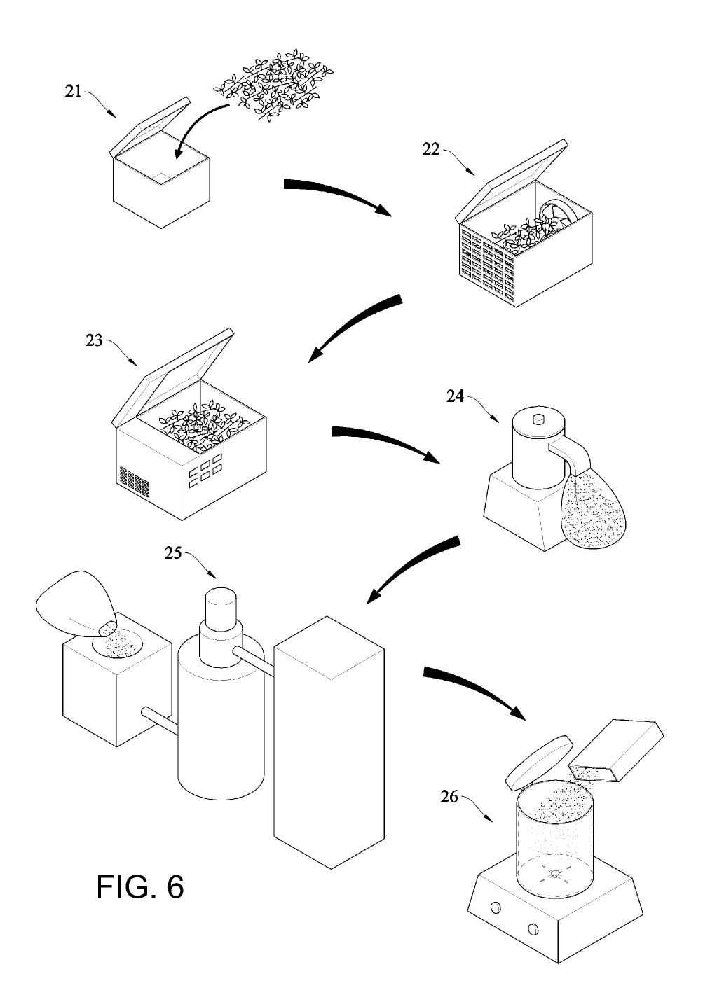

As shown in FIGS. 5 and 6, the processing apparatus 2 comprises a tank 21 associated with soaking step 13; a drying device 22 associated with wind drying step 14; a refrigeration device 23 disposed downstream of the drying device 22 for carrying out cool drying step 15; a coarse grinder 24 disposed downstream of the refrigeration device 23 for carrying out coarse pulverization step 16 in a low temperature environment; a fine grinder 25 disposed downstream of the coarse grinder 24 for carrying out fine pulverization step 17 in a low temperature environment; and a blending device 26 disposed downstream of the fine grinder 25 for uniformly mixing the fine food powder with other desired food powder prior to packaging (step 19).

The characteristics of the second preferred embodiment are substantially the same as that of the first preferred embodiment except the following:

Food additives adding step 18 follows fine pulverization step 17 and involves adding desired substances to the fine food powder in order to preserve flavor and/or enhance its taste and appearance.

A blending device 26 is disposed downstream of the fine grinder 25 for uniformly mixing the fine food powder with other desired food powder prior to packaging (step 19).

By observing above steps in mind, consumers may consult with experts or dealers about how to prepare health food from the fine food powder.

Herbs have been taken as health food in Asia for a long time. Recently, such trend has spread to Western world. Herbal medicine is included in Traditional Chinese Medicine which has been practiced by Chinese people for thousand years. Consumers may take advantage of the food processing method of the invention to process a wide range of food sources, including but not limited to, plants, into nanometer grade powder. Consumers may pour water into a cup filled with the fine food powder to solve same prior to drinking. Alternatively, consumers may eat the tablets or capsules, or drink the carton containing solved fine food powder directly. Such nanometer powder can be quickly consumed by humans.

Plants employed by the invention can be grown in regions full of water for quick harvest. Moreover, any plants having quick growth and non-toxicity features can be chosen as plant-based foods by the invention.

The invention has the following advantages:

(1) The invention involves soaking plants in water full of oxygen for revitalizing cells. Such plant-based foods can be employed as food reserves, emergency foods, and foods for disaster relief. Further, it can solve world hunger crisis.

(2) 800 kg powder can be obtained from 10 tons plants. Thus, the invention can obtain nutrients from plants, reduce food weight, save storage space, decrease transportation cost, and facilitate shipping.

(3) Wind drying and cool drying steps are performed so as to preserve nutrients contained in the plants. Further, fine plant powder can be quickly absorbed for providing sufficient energy for daily work.

(4) The invention involves a dry pulverization step to grind plants into fine food powder sized less than 1 μm by using a fine grinder by breaking cell walls of the food powder in a low temperature environment so as to substantially releasing nutrients contained in the food powder. People can pour the powder into cup filled with warm water prior to drinking.

(5) The invention involves a wet pulverization step to grind plants into fine food powder sized less than 1 μm by using a fine grinder by breaking cell walls of the food powder in a low temperature environment so as to substantially releasing nutrients contained in the food powder. After eating, the fine plant powder can be quickly absorbed by digestive organs of human beings.

(6) The invention involves soaking plants in water full of oxygen for revitalizing cells. Such plant-based foods are beneficial to health.

(7) The plant-based foods of the invention can be mixed with other food powder to prepare packaged foods. They are very good to health.

(8) The powder of the invention can be packaged in the forms of tablet or capsule for consumption. Alternatively, the powder of the invention can be packaged in cartons containing solved fine food powder as food manufacturer selection.

While the invention has been described in terms of preferred embodiments, those skilled in the art will recognize that the invention can be practiced with modifications within the spirit and scope of the appended claims.

What is claimed is:

1. A method of processing food comprising the steps of:
(A) collecting and storing non-toxic, no heavy metal polluted plants as food sources;
(B) separating, classifying, and cutting the plants;
(C) soaking the plants in water containing a predetermined concentration of oxygen for a predetermined period of time;
(D) drying the plants by blowing in the wind in a predetermined temperature range;
(E) further drying the plants by freezing;
(F) pulverizing the dried plants into coarse food powder of a predetermined size;
(G) further pulverizing the coarse food powder into nanometer scale food powder; and
(H) packaging the nanometer scale food powder into packages.

2. The method of claim 1, further comprising the step of adding food additives to the nanometer scale food powder after step (G) and before step (H).

3. The method of claim 1, wherein the plants are green teas, roses, jasmine teas, ginseng, cinnamon, or grains of paradise.

4. The method of claim 1, wherein the predetermined period of time is about 20 minutes and the predetermined concentration of oxygen is about 20-60 ppm.

5. The method of claim 1, wherein the predetermined temperature range is less than 35° C.

6. The method of claim 1, wherein the predetermined size of step (F) is about 100 μm.

7. The method of claim 1, wherein the nanometer scale food powder is sized less than 1 μm.

8. The method of claim 2, wherein the food additives of step (H) are chosen from other plant-based food powders.

9. The method of claim 1, wherein the packages are cartons, tablets, capsules, or cartons containing the nanometer scale food powder being solved.

10. An apparatus of processing food comprising:
a tank;
a drying device disposed downstream of the tank;
a refrigeration device disposed downstream of the drying device;
a coarse grinder disposed downstream of the refrigeration device;
a fine grinder disposed downstream of the coarse grinder; and
a blending device disposed downstream of the fine grinder.
